(19) United States
(12) Patent Application Publication
(10) Pub. No.: US 2018/0296948 A1
(43) Pub. Date: Oct. 18, 2018

(54) OIL FILTER

(71) Applicant: Komatsu Ltd., Tokyo (JP)

(72) Inventors: Akira Hasebe, Oyama-shi (JP); Hiroyuki Chikugo, Oyama-shi (JP); Shuuji Hori, Oyama-shi (JP)

(21) Appl. No.: 15/519,971

(22) PCT Filed: Oct. 30, 2014
(86) PCT No.: PCT/JP2014/078929

§ 371 Date: Apr. 18, 2017

(51) Int. Cl. B01D 29/03; B01D 39/10

(52) U.S. Cl. CPC B01D 29/03; F15B 13/025; B01D 2201/184; B01D 39/10

(57) ABSTRACT

An oil filter includes a filter body including first and second plates stacked to each other, the first plate including a plurality of filtration holes, the second plate including a plurality of passage holes, an inner diameter of the passage holes being greater than an inner diameter of the filtration holes, the filtration holes facing the respective passage holes. Further, the first plate and the second plate are bonded to each other in a manner that a whole area of openings of the filtration holes is arranged within a range of openings of the passage holes.

### FIELD

The present invention relates to an oil filter which is provided in an oil passage to filter oil.

### BACKGROUND

In a valve device, such as a pressure reducing valve, applied to a hydraulic circuit, an oil filter is provided in an oil passage which is for supplying oil to a spool. As this kind of oil filter, there are oil filters using a wire net. In addition, however, in recent years, many oil filters have been provided having a filter body including a metal plate in which filtration holes are formed. Generally, the filtration holes are formed by etching. In those oil filters, it is unlikely that fluctuation in the filtration holes occurs due to fraying of the wire net. Therefore, it becomes possible to secure uniform and stable filtration performance.

However, when the filtration holes are formed by etching, a plate thickness of an applicable metal plate is greatly restricted. That is, when the plate thickness of the metal plate is increased, time to perform etching becomes longer. Therefore, it becomes difficult to accurately form the inner diameter of the filtration holes, for example, form the filtration holes in a conical shape.

Therefore, the applicant of the present invention has already provided an oil filter in which a filtration hole is formed by performing etching from one surface of a metal plate, which is a filter body, to a half of the plate in the thickness direction and performing etching from the other surface of the metal plate (for example, see Patent Literature 1). However, in the oil filter according to Patent Literature 1, the plate thickness of a part through which oil passes is approximately half of that of the metal plate. Therefore, there may be a case where the oil filter does not have a sufficient strength depending on the amount of the oil passing through an oil passage.

On the other hand, as a related art of the oil filter, there is an oil filter, which includes a filter body having filtration holes having a desired inner diameter, formed by laminating a plurality of metal plates where through-holes have been formed and bonding the metal plates in a state where the through-holes are mutually shifted (for example, see Patent Literature 2). According to the oil filter disclosed in Patent Literature 2, the strength of the filter body is improved by boding the plurality of metal plates. Therefore, sufficient strength can be expected even when the oil filter is applied to an oil passage through which a large amount of oil passes. In addition, since the plate thickness of each metal plate where the through-holes are formed can be reduced, it becomes possible to accurately form the through-holes by etching.

### CITATION LIST

### Patent Literature

Patent Literature 1: WO 2012/029431 A

Patent Literature 2: Korea Patent Publication No. 10-2007-0066734 A

### SUMMARY

### Technical Problem

However, in the oil filter according to Patent Literature 2, even in a case where the through-holes are accurately formed, a slight gap which is generated when the metal plates are stacked, greatly affects the dimension of the filtration holes, and it is extremely difficult to manage the filtration performance.

In light of the above circumstances, an object of the present invention is to provide an oil filter which makes easier to manage the filtration performance and secure the sufficient strength.

### Solution to Problem

To attain the above object, an oil filter according to the present invention is provided in an oil passage and for filtering oil by causing the oil, which flows through the oil passage, to pass through filtration holes of a filter body. In the oil filter, the filter body is formed by stacking plates to each other where the filtration holes and passage holes having an inner diameter greater than that the inner diameter of the filtration holes are formed at places facing each other and bonding the plates in a manner that a whole area of an opening of the filtration holes is arranged to be positioned within a range of an opening of the passage holes.

Further, according to the present invention, in the above oil filter, the filter body is formed by bonding a reference plate in which the plurality of filtration holes are formed and a cover plate in which the plurality of passage holes are formed to each other.

Further, according to the present invention, in the above oil filter, the cover plate has a plate thickness greater than the plate thickness of the reference plate.

Further, according to the present invention, in the above oil filter, the plates are stacked in a form in which the passage holes are arranged at respective openings on both ends of the filtration hole.

Further, according to the present invention, in the above oil filter, the filtration hole is arranged for each of the passage holes.

Further, according to the present invention, in the above oil filter, the plates are stacked to each other in a manner that centers of the passage holes coincide with respective centers of the filtration holes.

### Advantageous Effects of Invention

According to the present invention, a filter body is formed by laminating a plurality of plates, which is advantageous to have a greater strength. Therefore, it is less likely to cause a damage even when the filter body is applied to an oil passage through which a large amount of oil passes. In addition, the plate thickness of the plate in which the filtration holes are formed can be reduced. Therefore, a dimensional accuracy can be improved even when the filtration holes are formed by etching, and it is possible to easily manage the filtration performance.

### BRIEF DESCRIPTION OF DRAWINGS

FIG. 1 is a diagram of an oil filter according to an embodiment of the present invention.

FIG. 2 is an enlarged sectional view of a main part of the oil filter illustrated in FIG. 1.

FIG. 3 is a disassembled perspective view of the oil filter illustrated in FIG. 1.

FIG. 4 is a perspective view of the oil filter illustrated in FIG. 1.

FIG. 5 is an enlarged sectional view of a main part of a modified example of the oil filter illustrated in FIG. 1.

### DESCRIPTION OF EMBODIMENTS

A preferred embodiment of an oil filter according to the present invention is described in detail below with reference to the accompanied drawings.

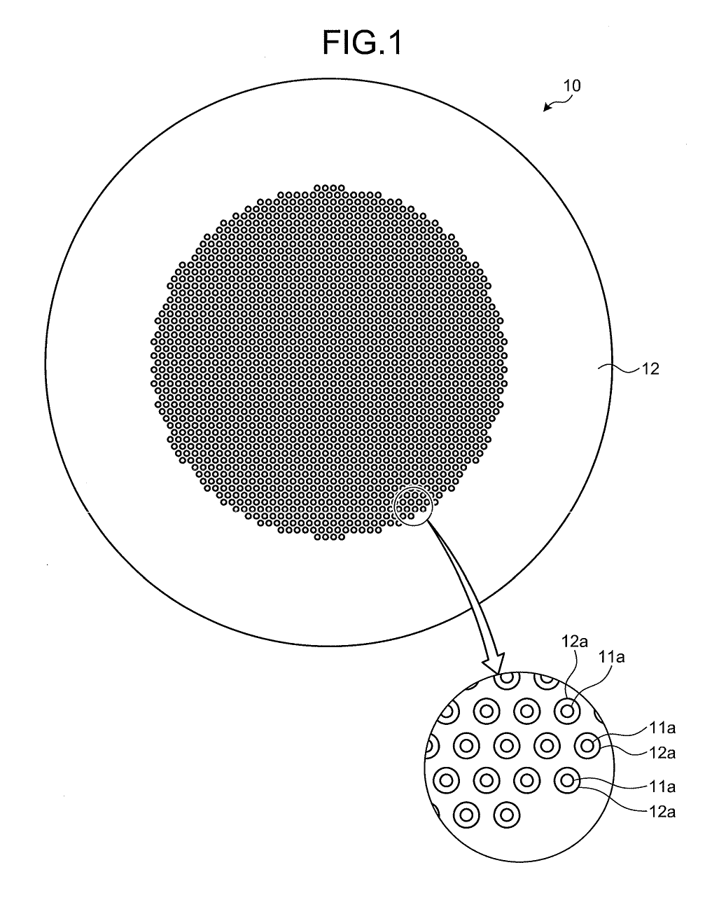

FIG. 1 is a diagram of an oil filter according to an embodiment of the present invention. The oil filter exemplified here filters oil in an oil passage through which a relatively large amount of oil passes. For example, the amount of oil is approximately 20 liters per minute. The oil filter includes a filter body 10.

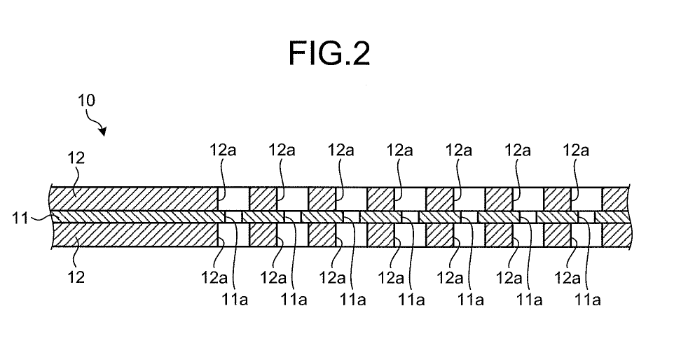

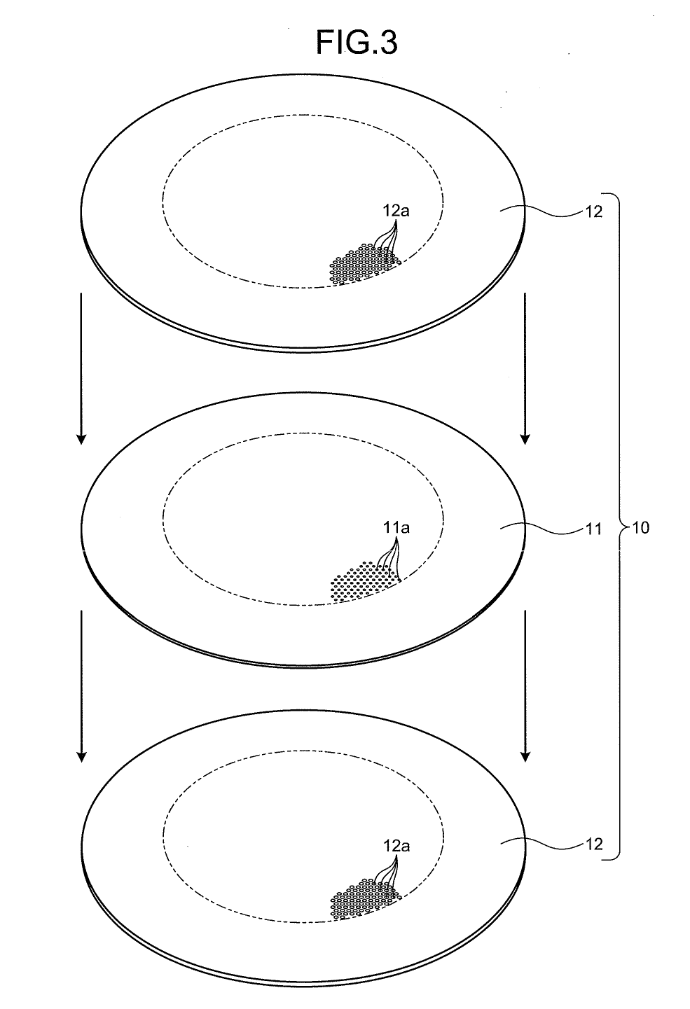

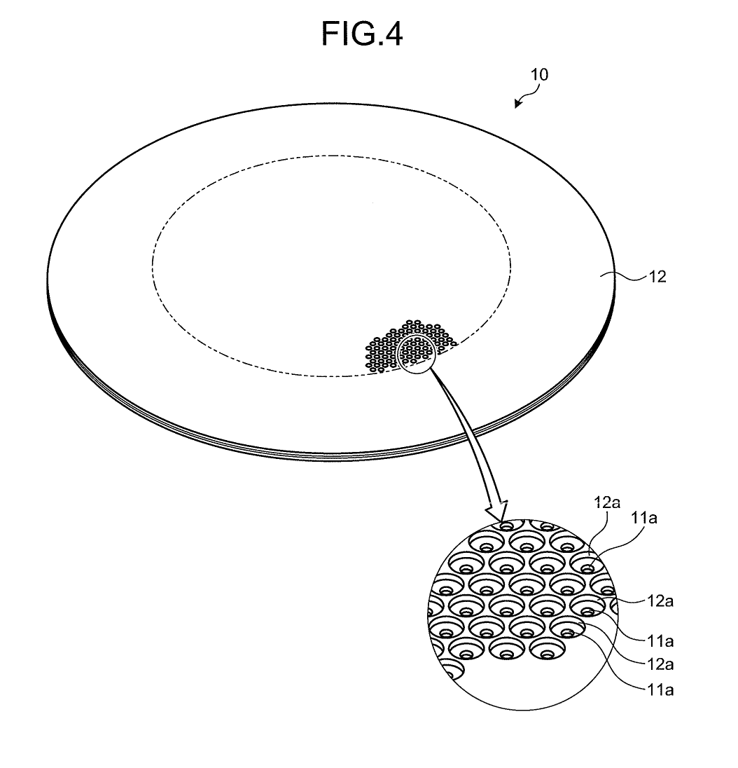

The filter body 10 is formed by laminating and bonding three thin metal plates 11 and 12 to each other as illustrated in FIGS. 2 to 4. In the present embodiment, the filter body 10 includes a single reference plate 11 and two cover plates 12. Each of the reference plate 11 and the cover plates 12 is formed in a disk-like shape and has the same outer diameter. The plate thickness of each of the two cover plates 12 is approximately two-times greater than that of the reference plate 11.

The reference plate 11 includes a plurality of filtration holes 11a in a center part of its circular plate. Each filtration holes 11a are through-holes having an inner diameter required for performing a desired filtration performance, and the filtration holes 11a are arranged in a circular region provided in the center part of the reference plate 11 in a uniformly distributed manner.

Each of the cover plates 12 includes a plurality of passage holes 12a in the center part of its circular plate. Each passage hole 12a is a through-hole having an inner diameter slightly greater than that of the filtration hole 11a of the reference plate 11, and the passage holes 12a are formed at parts facing the respective filtration holes 11a. The filtration holes 11a of the reference plate 11 and the passage holes 12a of the cover plate 12 are formed by etching.

The cover plate 12 is stacked on each of the both sides of the reference plate 11 in a manner that the center of the passage holes 12a coincide with the center of the respective filtration holes 11a on a one-to-one basis and the passage holes 12a are arranged at the openings on the respective ends of the filtration hole 11a. The reference plate 11 and the cover plates 12 are positioned in a manner that the whole area of the opening of the filtration holes 11a is arranged within a range of the openings of the passage holes 12a. After that, by bonding the reference plate 11 and the cover plates 12, the filter body 10 of the oil filter can be formed. As a method of bonding the reference plate 11 and the cover plates 12, an adhesive can be used. However, it is preferable to employ diffusion bonding.

When the oil filter formed as described above is disposed in an oil passage, the oil passing through the oil filter is filtered by the filtration holes 11a having the inner diameters smaller than those of the passage holes 12a. Here, in the oil filter described above, the filter body 10 is formed by stacking the cover plates 12 on the respective surfaces of the reference plate 11. Therefore, even when the oil filter is disposed in the oil passage through which a large amount of oil passes, there is no risk of easily being damaged. In addition, the thickness of the reference plate 11, in which the filtration holes 11a are formed, is approximately one half of that of the cover plate 12, and such reference plate 11 is used. Therefore, a processing time to form the filtration holes 11a by etching can be shortened, and high dimensional accuracy of the inner diameter can be secured. Therefore, the filtration performance as the oil filter can be easily managed.

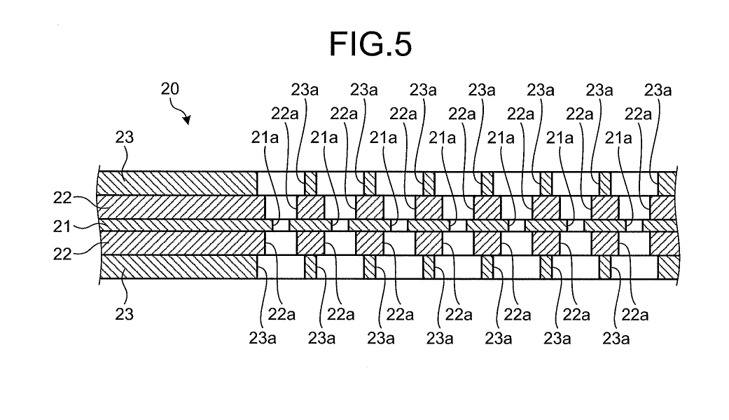

In the above embodiment, a case is described where the filter body 10 is formed by using one reference plate 11 and two cover plates 12. However, the number of the plates to be stacked is not limited to this. For example, as illustrated in a modified example in FIG. 5, when a filter body 20 is formed by stacking two cover plates 22 and 23 on each surface of a reference plate 21 in which the filtration holes 21a are formed, the strength can be further enhanced. In this case, in the cover plate 23 arranged at the outermost side, it is preferable to form the passage holes 23a having inner diameters greater than those of the passage holes 22a formed in the inner cover plate 22 to reduce a pressure loss.

Further, in the above embodiment, since the same cover plates 12 are stacked on the respective surfaces of the reference plate 11, the same filtration performance can be obtained regardless of the oil passing direction. There is no need to consider the disposing direction of the oil filter in the oil passage. However, in the present invention, it may be enough to stack the cover plate on a single surface of the reference plate. In this case, the plate thickness of the cover plate does not affect the filtration performance as the oil filter. Therefore, for example, when a cover plate which is four times thicker than that of the reference plate is applied, the strength similar to that in the embodiment can be secured.

In addition, in the above embodiment, the filtration holes 11a are formed in one plate 11 to be stacked, and only the passage holes 12a are formed in the other plates 12. However, when the plates can be stacked so that the filtration holes and the respective passage holes are arranged to face each other, the filtration holes and the passage holes may be provided in the plates in a mixed manner.

In addition, in the above embodiment and the modified example, the cover plates 12, 22, and 23 having the plate thickness thicker than those of the reference plates 11 and 21 are applied. However, the plate thickness of the reference plate may be the same as that of the cover plate, and a cover plate having the plate thickness less than that of the reference plate may be applied.

### REFERENCE SIGNS LIST

10, 20 FILTER BODY

11, 21 REFERENCE PLATE

11a, 21a FILTRATION HOLE

12, 22, 23 COVER PLATE

12a, 22a, 23a PASSAGE HOLE

1-6 (canceled)

7. An oil filter comprising:
a filter body including first and second plates stacked to each other, the first plate including a plurality of filtration holes, the second plate including a plurality of passage holes, an inner diameter of the passage holes being greater than an inner diameter of the filtration holes, the filtration holes facing the respective passage holes,
wherein the first plate and the second plate are bonded to each other in a manner that a whole area of openings of the filtration holes is arranged within a range of openings of the passage holes.

8. The oil filter according to claim 7, wherein the first plate is a reference plate and the second plate is a cover plate.

9. The oil filter according to claim 8, wherein a plate thickness of the cover plate is greater than a plate thickness of the reference plate.

10. The oil filter according to claim 7, wherein the filter body includes two second plates, wherein the first plate is sandwiched by the two second plates in a manner that the passage holes are arranged at respective openings on both ends of the filtration holes.

11. The oil filter according to claim 7, wherein the filtration holes are arranged to correspond to the passage holes.

12. The oil filter according to claim 7, wherein centers of the passage holes coincide with respective centers of the filtration holes.

13. The oil filter according to claim 10, wherein two or more second plates are stacked to one or both sides of the first plate.
